(19) United States
(12) Patent Application Publication
(10) Pub. No.: US 2018/0259077 A1
(43) Pub. Date: Sep. 13, 2018

(54) INTEGRATED CHECK-RELIEF VALVE

(71) Applicant: BorgWarner Inc., Auburn Hills, MI (US)

(72) Inventor: Toru SHINOYAMA, Mie (JP)

(21) Appl. No.: 15/744,355

(22) PCT Filed: Jul. 13, 2016
(86) PCT No.: PCT/US2016/041974

§ 371 Date: Jan. 12, 2018

(30) Foreign Application Priority Data
Jul. 18, 2015 (JP) 2015-143523

(51) Int. Cl. F16K 15/02; F16K 15/04; F16K 17/04; F16K 17/196

(52) U.S. Cl. CPC F16K 15/028; F16K 17/196; F16K 17/0406; F16K 15/044

(57) ABSTRACT

Provided is an integrated check-relief valve in which a retreat amount of a valve seat member can be regulated when a relief valve is in operation, and an inclination of the valve seat member and a slant of a relief spring can be prevented. In an integrated check-relief valve 1 including a valve housing 2, inside the valve housing 2, a check ball 3 and a valve disk 4 with which the check ball 3 can come into contact are provided so as to be movable in an axial direction, a check spring 5 which urges the check ball 3 to the valve disk 4 side, a relief spring 6 which urges the valve disk 4 to the check ball 3 side, and a guide member 8 which guides the relief spring 6 from an inner circumference side are provided. A movement amount of the valve disk 4 with respect to a side where the relief spring 6 contracts is regulated by a distal end portion of the guide member 8.

### TECHNICAL FIELD

The present invention relates to an integrated check-relief valve, and specifically relates to an improvement of a structure thereof.

### BACKGROUND ART

JP-A-10-306857 discloses a tensioner provided with a check valve which has a function of a relief valve. The check valve has a valve housing, a valve member that is embedded on the inside thereof in a movable manner, a first valve seat member in which the valve member is seated, a second valve seat member that is fixed to the inside of the valve housing, a check spring that urges the valve member to the first valve seat member side, and a relief spring that urges the first valve seat member to the second valve seat member side (refer to Paragraphs [0060] to [0066] and FIGS. 1 to 3, 5, and 6 in JP-A-10-306857).

In the tensioner disclosed in PTL 1, when a plunger moves outward and pressure inside a chamber becomes lower than a predetermined minimum value during an operation, as the valve member moves to a side of being separate from the first valve seat member counteracting the spring force of the check spring, the check valve is opened. Accordingly, a fluid flows into the chamber from an external pressurized fluid source via a fluid introduction hole of a tensioner housing passing through the check valve (refer to Paragraph [0072] and FIG. 5 in JP-A-10-306857).

Meanwhile, when the plunger moves inward and the pressure inside the chamber becomes higher than a predetermined maximum value during an operation, as the first valve seat member moves to a side of being separate from the second valve seat member counteracting the spring force of the relief spring, the relief valve is opened. Accordingly, a high pressure fluid inside the chamber flows out through the relief valve via the fluid introduction hole of the tensioner housing (refer to Paragraph [0078] and FIG. 6 in JP-A-10-306857).

In the tensioner having the above-described configuration, in a case where the pressure inside the chamber becomes excessive during an operation, a movement amount (retreat amount) of the first valve seat member becomes excessive. As a result thereof, the first valve seat member inclines inside the valve housing, the first valve seat member becomes stuck inside the valve housing, and the relief spring slants in an axial line direction, thereby causing a possibility that spring force from the relief spring counteracted by the first valve seat member is not applied evenly in a circumferential direction. In addition, when the movement amount of the first valve seat member (retreat amount) becomes excessive, the movement amount of the valve member which moves together with the first valve seat member also becomes excessive. As a result thereof, there is a possibility that the check spring urging the valve member exceeds a contraction state and is in a free length state so that the urging force counteracted by the valve member is not present.

### SUMMARY OF INVENTION

### Technical Problem

The present invention has been made in consideration of the circumstances in the related art. An object to be achieved by the present invention is to provide an integrated check-relief valve which can regulate a retreat amount of a valve seat member when a relief valve is in operation and can prevent an inclination of the valve seat member and a slant of the relief spring.

### Solution to Problem

In order to achieve the above-described object, according to the present invention, there is provided an integrated check-relief valve including a valve housing. Inside the valve housing, a valve member and a valve seat member with which the valve member can come into contact are provided so as to be movable in an axial direction. A check spring which urges the valve member to the valve seat member side, a relief spring which urges the valve seat member to the valve member side, and a guide member which guides the relief spring from an inner circumference side are provided. A movement amount of the valve seat member with respect to a side where the relief spring contracts is regulated by a distal end portion of the guide member.

According to the present invention, when the check valve is opened during an operation, as the valve member moves to a side of being separate from the valve seat member counteracting the spring force of the check spring, a gap is formed between the valve member and the valve seat member, and thus, the check valve is opened. Meanwhile, when the relief valve is opened during an operation, as the valve seat member moves to a side where the relief spring contracts counteracting the spring force of the relief spring, a gap is formed on the periphery of the valve seat member, and thus, the relief valve is opened. In this case, the guide member guides movement of the relief spring.

In addition, in a case where the movement amount of the valve seat member becomes significant, the distal end portion of the guide member regulates the movement amount of the valve seat member (retreat amount), and the guide member guides movement of the relief spring when the valve seat member retreats. Accordingly, when the relief valve is in operation, before the retreat amount of the valve seat member becomes excessive, the distal end portion of the guide member regulates the retreat of the valve seat member. Therefore, the valve seat member can be prevented from inclining inside the valve housing and becoming stuck. Moreover, the guide member guides movement of the relief spring. Therefore, it is possible to prevent the relief spring from slanting in the axial line direction and spring force from the relief spring counteracted by the valve seat member from being applied unevenly in a circumferential direction. Furthermore, as the retreat amount of the valve seat member is regulated, the retreat amount of the valve member is also regulated. Accordingly, it is possible to reliably prevent a possibility that the check spring exceeds the contraction state and is in a free length state.

In the present invention, the guide member is a tubular member, a proximal end portion and the distal end portion thereof respectively have opening portions, and a cut-off which is connected to the opening portion on the distal end portion side or a penetration hole which is separate from an opening end surface on the distal end portion side is formed on an outer circumferential surface on the distal end portion side. In this case, the cut-off or the penetration hole is used as a flow channel.

In the present invention, the guide member is a tubular member, a proximal end portion thereof has an opening portion, the distal end portion thereof is blocked, and a penetration hole which is separate from an opening end surface on the distal end portion side is formed on an outer circumferential surface. In this case, the penetration hole is used as the flow channel.

In the present invention, the distal end portion of the guide member is provided with a projection portion with which the valve member can come into contact when the valve seat member retreats. In this case, as the valve member which retreats together with the valve seat member comes into contact with the projection of the distal end portion of the guide member, the retreat of the valve member is regulated, and it is possible to cause only the valve seat member to retreat further from the state.

In the present invention, a flow channel is formed in the distal end portion of the guide member. In this case, when the relief valve is in operation, the fluid passes through the relief valve via not only the gap on the periphery of the valve seat member but also the flow channel of the guide member. Therefore, it is possible to cause the fluid to smoothly move and to adjust the quantity of the moving fluid by the flow channel.

In the present invention, a proximal end portion of the guide member is provided with a flange portion which protrudes outward, the flange portion is fixed to an end portion of the valve housing, and one end of the relief spring comes into contact with the flange portion.

In the present invention, an opening portion is formed on an outer circumferential surface of the guide member, and an oil filter is mounted in the opening portion. In this case, a function of the oil filter can be added to the guide member.

In the present invention, the valve housing is a tubular member which is open on both a proximal end side and a distal end side, at least one open hole is formed in a lid body which is attached to an opening portion on the distal end side, and one end of the check spring comes into contact with the lid body.

In the present invention, the valve member is a check ball.

A liquid pressure tensioner according to the present invention includes the above-described integrated check-relief valve.

In the present invention, a tensioner housing that has a hole which is open in at least one end, a plunger that is slidably accommodated in the hole and defines a chamber with respect to the hole, and a plunger spring that is provided in the hole and urges the plunger in a direction of projecting from the hole are included. The integrated check-relief valve is provided inside the chamber, and an opening portion of a valve housing on a proximal end side communicates with a fluid introduction hole which is provided in the tensioner housing.

In the present invention, when the plunger is lengthened, if pressure of a fluid inside the chamber becomes lower than predetermined minimum pressure, the valve member moves to a side where the check spring contracts so as to form a gap between the valve member and the valve seat member, and the fluid inside the valve housing is introduced to the inside of the chamber through the gap. In addition, when the plunger contracts, if the pressure of the fluid inside the chamber exceeds predetermined maximum pressure, the valve seat member moves to the side where the relief spring contracts so as to form a gap on the periphery of the valve seat member and the fluid inside the chamber flows into the valve housing through the gap and flows out from the opening portion of the valve housing on the proximal end side, and if the pressure of the fluid inside the chamber becomes higher, additional movement of the valve seat member is regulated by the distal end portion of the guide member.

### Advantageous Effects of Invention

As described above, according to an integrated check-relief valve of the present invention, in a case where a movement amount of a valve seat member becomes significant when the relief valve is opened, a distal end portion of a guide member regulates the movement amount (retreat amount) of the valve seat member, and the guide member guides movement of a relief spring when the valve seat member retreats. Accordingly, when the relief valve is in operation, before the retreat amount of the valve seat member becomes excessive, the distal end portion of the guide member regulates the retreat of the valve seat member. Therefore, the valve seat member can be prevented from inclining inside the valve housing and becoming stuck. Moreover, the guide member guides movement of the relief spring. Therefore, it is possible to prevent the relief spring from slanting in the axial line direction and to prevent the spring force from the relief spring counteracted by the valve seat member from being applied unevenly in a circumferential direction.

### BRIEF DESCRIPTION OF DRAWINGS

FIG. 1 is a schematic diagram of a longitudinal sectional view of a chain tensioner which includes an integrated check-relief valve of an exemplary embodiment of the present invention in which a plunger is in a maximum contraction state.

FIG. 2 is a longitudinal sectional view illustrating a configuration of the integrated check-relief valve (FIG. 1).

FIG. 3 is a partially enlarged view of the integrated check-relief valve (FIG. 2).

FIG. 4 is a planar view (top view) of the integrated check-relief valve (FIG. 2).

FIG. 5 is an overall prospective view of a guide member configuring the integrated check-relief valve (FIG. 2).

FIG. 6 is a diagram for describing a state of the integrated check-relief valve (FIG. 3) when a check valve is opened.

FIG. 7 is a diagram for describing a state of the integrated check-relief valve (FIG. 3) when a relief valve is opened.

FIG. 8 is a diagram for describing a function of the guide member when the relief valve of the integrated check-relief valve (FIG. 3) is opened.

FIG. 9 is a longitudinal sectional view illustrating a configuration of the integrated check-relief valve in a modification example of the present invention.

FIG. 10 is a partially enlarged view of the integrated check-relief valve (FIG. 9).

FIG. 11 is an overall prospective view of the guide member configuring the integrated check-relief valve (FIG. 9).

FIG. 12 is a diagram for describing a state of the integrated check-relief valve (FIG. 10) when the relief valve is opened.

FIG. 13 is a diagram for describing a function of the guide member when the relief valve of the integrated check-relief valve (FIG. 10) is opened.

FIG. 14 is a diagram illustrating a modification example of the guide member (FIG. 11).

FIG. 15 is a longitudinal sectional view illustrating a configuration of the integrated check-relief valve in an alternative modification example of the present invention.

FIG. 16 is a partially enlarged view of the integrated check-relief valve (FIG. 15).

FIG. 17 is a planar view of a lid body configuring the integrated check-relief valve (FIG. 15).

### DESCRIPTION OF EMBODIMENTS

Hereinafter, an exemplary embodiment of the present invention will be described with reference to the accompanying drawings.

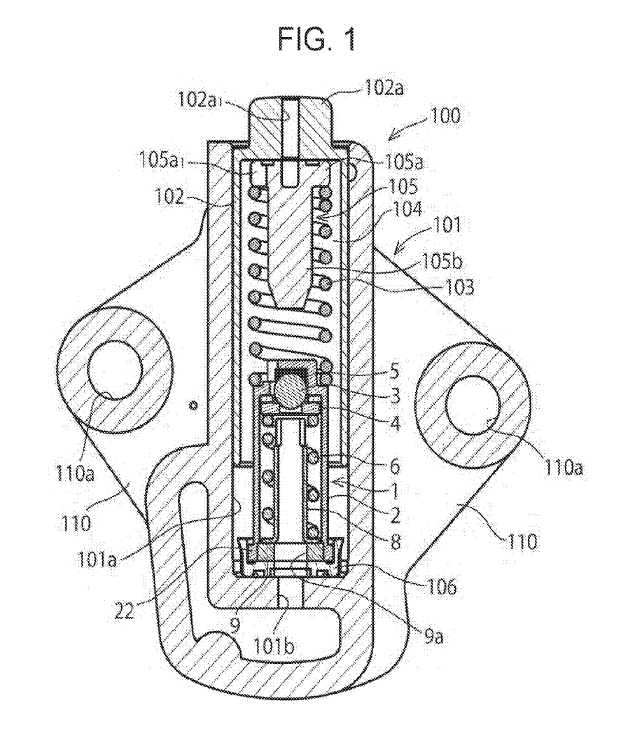

FIGS. 1 to 8 are diagrams for describing an integrated check-relief valve (hereinafter, will be simply referred to as the “check-relief valve”) of the exemplary embodiment of the present invention. Here, an example in which the check-relief valve is applied to a liquid pressure tensioner is illustrated. In the description below, for convenience of description, in each of longitudinal sectional views of the liquid pressure tensioner and the check-relief valve in which a distal end of a plunger is illustrated as being oriented upward, the upward direction (upper side) and the downward direction (lower side) in each diagram are respectively referred to as the upward direction (upper side) and the downward direction (lower side, bottom side, and bottom surface side) of the liquid pressure tensioner and the check-relief valve.

As illustrated in FIG. 1, a liquid pressure tensioner 100 includes a tensioner housing 101 that has a hole 101a which is open in one end, a hollow plunger 102 which is slidably accommodated inside the hole 101a, a plunger spring 103 which is arranged inside the hole 101a and urges the plunger 102 in a direction of projecting from the hole 101a, and a check-relief valve 1 which is provided in the bottom portion of the hole 101a. For example, a distal end portion 102a of the plunger 102 comes into contact with a chain (not illustrated), thereby being used so as to apply tensile force to the chain. A fluid introduction hole 102a₁ is formed in the distal end portion 102a. FIG. 1 illustrates a state where the plunger 102 maximally contracts (that is, the plunger 102 moves in a retreating direction).

On the bottom wall of the hole 101a of the tensioner housing 101, a fluid introduction hole (oil supply hole) 101b is formed in a penetrating manner, and a fluid supplied from an external pressurized fluid source (not illustrated) is introduced through the fluid introduction hole (oil supply hole) 101b. The internal space of the plunger 102 and the hole 101a define a chamber 104 which accumulates the fluid, and the fluid introduction hole 101b communicates with the chamber 104. Inside the chamber 104, a vent disk 105 for discharging air which is incorporated into the chamber 104, through the fluid introduction hole 102a₁ in the distal end portion 102a of the plunger 102 together with the fluid is disposed. The vent disk 105 has a head portion 105a which has a large diameter and in which a flow channel 105a₁ is formed, and a shaft portion 105b which has a small diameter and extends downward from a lower surface of the head portion 105a. A top surface of the head portion 105a comes into contact with an inner wall surface of the distal end portion 102a of the plunger 102, and the upper end of the plunger spring 103 comes into contact with the lower surface of the head portion 105a. The shaft portion 105b is inserted into the inner space of the plunger spring 103. In addition, the tensioner housing 101 has a flange 110 which protrudes outward. In the flange 110, a screw insertion hole 110a is formed in a penetrating manner, and an attachment screw for attaching the liquid pressure tensioner 100 to an external installation wall (for example, an engine block and the like) is inserted into the screw insertion hole 110a.

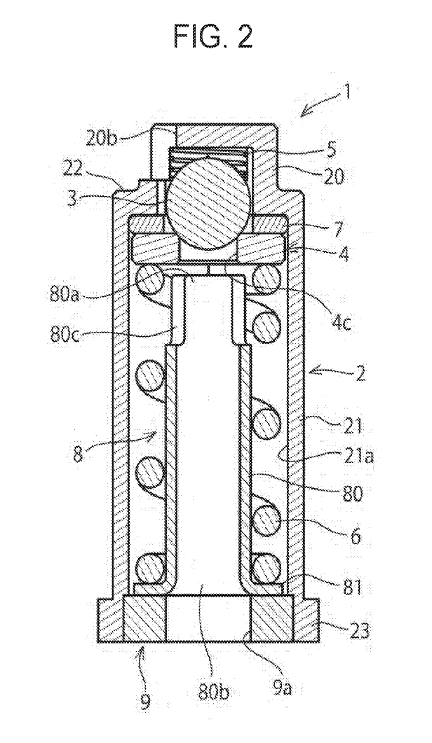

As illustrated in FIG. 2, the check-relief valve 1 has a valve housing 2. The valve housing 2 has a tubular bottomed small diameter portion 20 which is disposed at the upper end and a tubular large diameter portion 21 which is integrally formed at the lower end thereof, extends downward, and having a diameter larger than the small diameter portion 20. Between the small diameter portion 20 and the large diameter portion 21, a step portion 22 is formed. Inside the small diameter portion 20, a check ball (valve member) 3 is provided so as to be movable in the axial direction and the check ball 3 is formed with a solid ball. Inside the large diameter portion 21, a valve disk (valve seat member) 4 is provided so as to be movable in the axial direction and the check ball 3 can come into contact with the valve disk 4. In addition, inside the small diameter portion 20, a check spring 5 is arranged and the check spring 5 urges the check ball 3 to the valve disk 4 side. Inside the large diameter portion 21, a relief spring 6 is arranged and the relief spring 6 urges the valve disk 4 to the check ball 3 side. Inside the large diameter portion 21, the inner wall surface of the step portion 22 is provided with a pressure sheet 7 and the valve disk 4 can come into contact with the pressure sheet 7 from below.

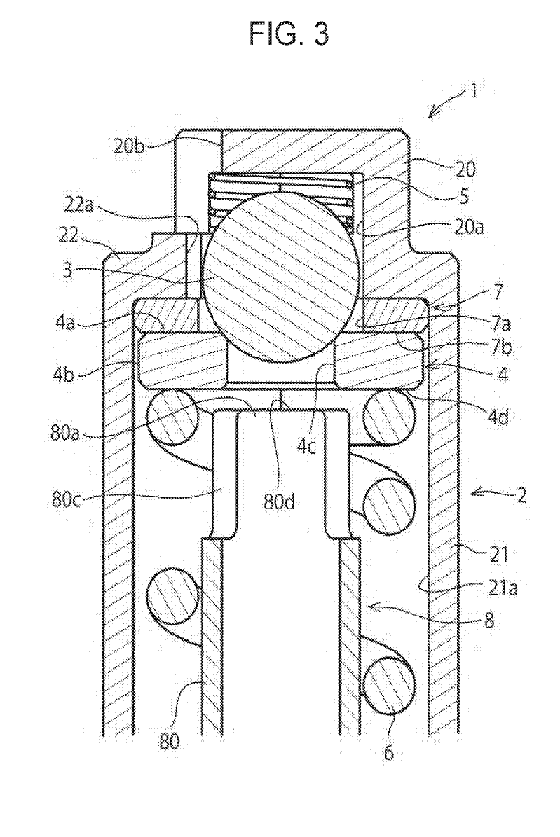

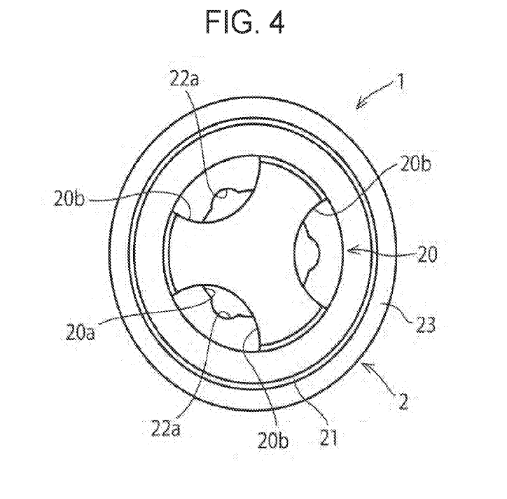

As illustrated in FIGS. 3 and 4, a hole 20a is formed in a central portion of the small diameter portion 20, the check ball 3 is accommodated inside the hole 20a. On an inner circumferential surface of the hole 20a, one or a plurality (three in this case) of concave portions 22a are formed and the concave portions 22a are disposed at equal intervals on the circumference. At positions respectively corresponding to the concave portions 22a in an outer circumferential portion of the small diameter portion 20, cut-offs 20b are formed and the cut-offs 20b communicate with the concave portions 22a and the hole 20a. The hole 20a areas of each concave portion 22a on both sides face the opening portion of the cut-off 20b when viewed from above. The cut-offs 20b communicated with the chamber 104 of the liquid pressure tensioner 100 through the concave portions 22a, the hole 20a, and an open hole 7a at the center of the pressure sheet 7. A top surface 4a of the valve disk 4 comes into contact with a lower surface 7b of the pressure sheet 7, and the lower surface 7b of the pressure sheet 7 functions as a sheet surface of the valve disk 4.

As illustrated in FIG. 3, the valve disk 4 is a substantially disk-shaped member, and an outer circumferential surface 4b is designed to have a size so as to have a minute gap with respect to an inner circumferential surface 21a of the large diameter portion 21. An open hole 4c is formed at the center of the valve disk 4. The check ball 3 comes into contact with an opening edge portion of the open hole 4c from above, and an upper side opening edge portion of the open hole 4c functions as the sheet surface of the check ball 3. The upper end of the relief spring 6 comes into contact with a lower surface 4d of the valve disk 4. On the bottom surface side of the valve disk 4, one or a plurality of vent grooves (four in this example) which are open may be formed on the outer circumferential surface 4b (not illustrated).

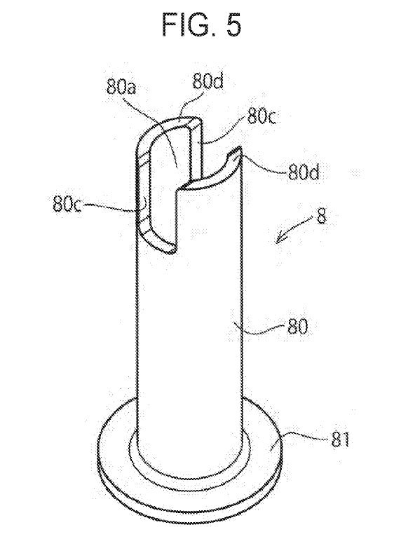

As illustrated in FIG. 2, inside the valve housing 2, a substantially tubular guide member 8 is provided and the guide member 8 guides the relief spring 6 from an inner circumference side. The guide member 8 is open at upper and lower ends and includes a tubular main body portion 80 which has an opening portion 80a at the distal end and has an opening portion 80b at a proximal end. The guide member 8 includes a flange portion 81 which is provided at the proximal end of the main body portion 80 and protrudes radially outward (refer to FIG. 5).

On an outer circumferential surface of the main body portion 80 on the distal end portion side, as illustrated in FIG. 5, cut-offs 80c are formed and are connected to the opening portion 80a. In this example, the cut-offs 80c are respectively disposed at two positions on the outer circumferential surface so as to face each other. As illustrated in FIG. 3, a distal end surface 80d of the main body portion 80 has a uniform gap with respect to the lower surface 4d of the valve disk 4 in a state where the valve disk 4 comes into contact with the pressure sheet 7.

As illustrated in FIG. 1, the lower end of the relief spring 6 comes into contact with the top surface of the flange portion 81. Meanwhile, in a lower side opening portion of the valve housing 2, as illustrated in FIG. 2, an end plate 9 having an open hole 9a at the center is fixedly attached by performing press-fitting or the like. The open hole 9a communicates with the fluid introduction hole 101b of the tensioner housing 101 of the liquid pressure tensioner 100 (refer to FIG. 1). The lower surface of the flange portion 81 is fixedly attached to the top surface of the end plate 9.

In addition, on the outer circumferential surface of the valve housing 2 on the proximal end portion side, a boss portion 23 having a large diameter is formed. As illustrated in FIG. 1, the boss portion 23 is configured to be fixed to the bottom portion of the hole 101a of the tensioner housing 101 via a seal member 106.

Subsequently, an operational effect of the present exemplary embodiment will be described.

During an operation of the liquid pressure tensioner 100, the fluid from the external pressurized fluid source is introduced into the chamber 104 through the fluid introduction hole 101b of the tensioner housing 101, the chamber 104 is filled with the fluid, and outward pressing force with respect to the plunger 102 caused by liquid pressure applied by the fluid inside the chamber 104 and the urging force of the plunger spring 103 is balanced with the pressing force from the chain which comes into contact with the distal end portion 102a of the plunger 102.

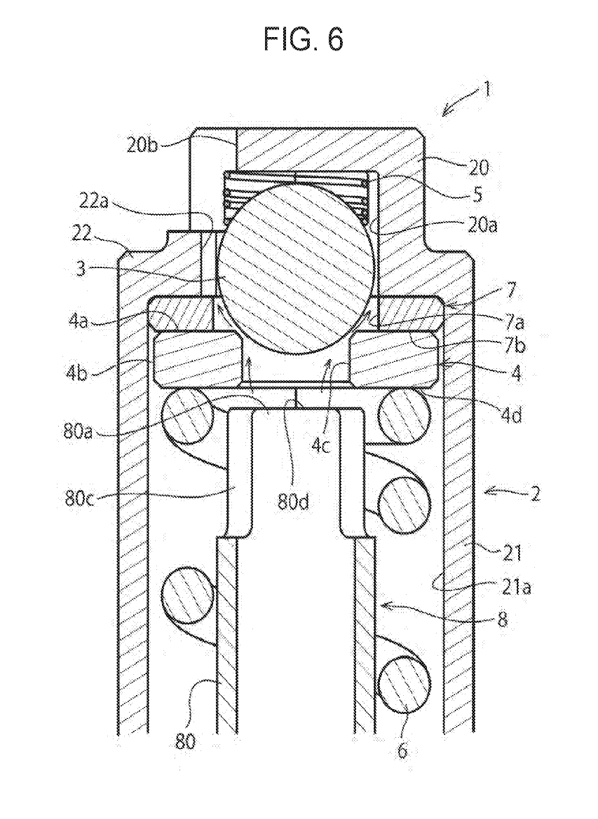

When the chain is stretched during an operation, the plunger 102 is lengthened (that is, moves in a projecting direction) and liquid pressure inside the chamber 104 is lowered. However, in this case, if the liquid pressure inside the chamber 104 becomes lower than a predetermined minimum pressure, the check ball 3 moves upward counteracting the spring force of the check spring 5. As a result thereof, a gap is formed between the check ball 3 and the valve disk 4, and thus, the check valve is opened (refer to FIG. 6). Accordingly, the fluid inside the valve housing 2 moves upward through the gap (refer to the arrow in FIG. 6), and the fluid is introduced into the chamber 104 from a penetration hole 7a of the pressure sheet 7 through the hole 20a of the small diameter portion 20, the concave portions 22a, and the cut-offs 20b. Then, when the pressing force from the plunger 102 with respect to the chain applied by the resultant force of the liquid pressure inside the chamber 104 and the urging force of the plunger spring 103 is balanced with the pressing force from the chain counteracted by the plunger 102, the check ball 3 moves downward and comes into contact with the valve disk 4, and the check valve is closed.

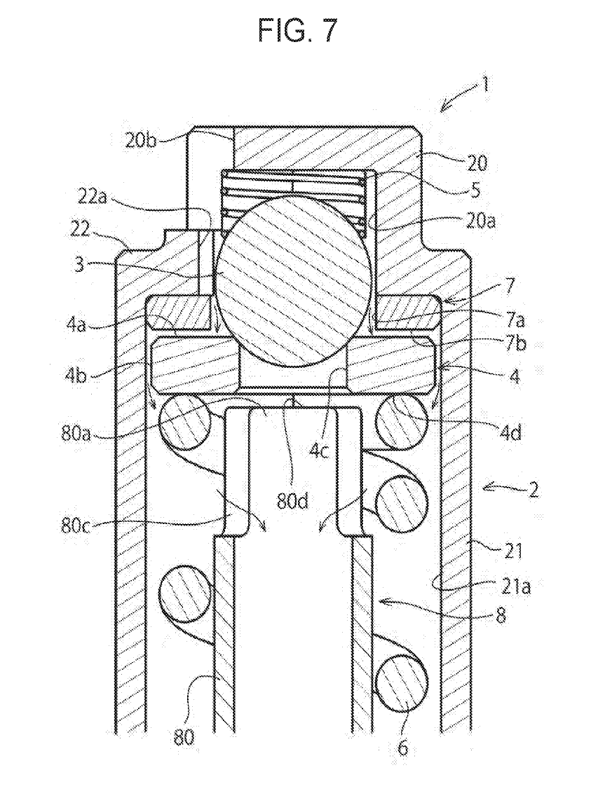

Meanwhile, during an operation, when pressing force from the chain counteracted by the plunger 102 is increased, the plunger 102 tends to move in a contraction direction (retreating direction) and the liquid pressure inside the chamber 104 increases. However, in this case, when the liquid pressure inside the chamber 104 exceeds a predetermined maximum pressure, the valve disk 4 moves downward (retreats) counteracting the spring force of the relief spring 6. As a result thereof, a gap is formed between the top surface 4a of the valve disk 4 and the lower surface 7b of the pressure sheet 7, and the relief valve is opened (refer to FIG. 7). Accordingly, the fluid inside the chamber 104 passes through the open hole 7a of the pressure sheet 7 from the cut-offs 20b, the concave portions 22a and the hole 20a of the small diameter portion 20 of the valve housing 2. Furthermore, the fluid inside the chamber 104 passes through the gap between the pressure sheet 7 and the valve disk 4, and the gap between the outer circumferential surface 4b of the valve disk 4 and the inner circumferential surface 21a of the large diameter portion 21, thereby moving downward (refer to the arrow in FIG. 7). The fluid inside the chamber 104 flows into the guide member 8 through the cut-offs 80c of the guide member 8 and flows out through the open hole 9a of the end plate 9 of the valve housing 2 on the proximal end side.

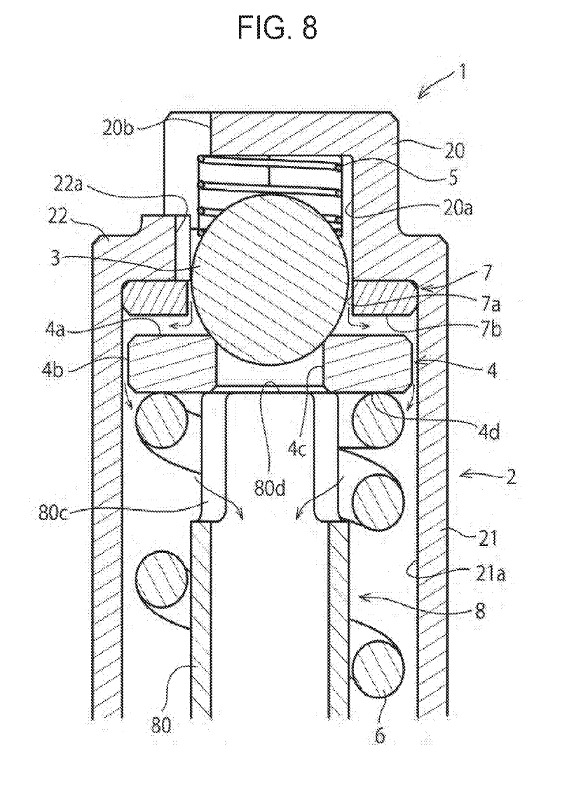

Subsequently, in a case where the liquid pressure inside the chamber 104 becomes higher, when a movement amount of the valve disk 4 reaches a predetermined movement amount, the valve disk 4 moves downward while causing the relief spring 6 to contract further, and the lower surface 4d of the valve disk 4 comes into contact with the distal end surface 80d of the main body portion of the guide member 8 from above. Accordingly, movement of the valve disk 4 is regulated (refer to FIG. 8). In this case, the gap between the top surface 4a of the valve disk 4 and the lower surface 7b of the pressure sheet 7 is wider. Therefore, the quantity of the fluid flowing into the valve housing 2 and the guide member 8 through the gap increases. In addition, in this case, the movement at the time the relief spring 6 contracts is guided by the main body portion 80 of the guide member 8.

In this manner, when the relief valve is in operation, before the retreat amount of the valve disk 4 becomes excessive, the retreat of the valve disk 4 is regulated by the distal end surface 80d of the main body portion 80 of the guide member 8. Therefore, the valve disk 4 can be prevented from inclining inside the valve housing 2 and becoming stuck. Moreover, the guide member guides movement of the relief spring 6 at all times. Therefore, it is possible to prevent the relief spring 6 from slanting in an axial line direction and to prevent the spring force from the relief spring 6 counteracted by the valve disk 4 from being applied unevenly in a circumferential direction. Furthermore, as the retreat amount of the valve disk 4 is regulated, the retreat amount of the check ball 3 is also regulated. Accordingly, it is possible to reliably prevent a possibility that the check spring 5 exceeds the contraction state and is in a free length state.

Hereinbefore, a favorable exemplary embodiment of the present invention has been described. However, application of the present invention is not limited thereto, and the present invention includes various modification examples. Hereinafter, several modification examples will be exemplified.

### First Modification Example

The above-described exemplary embodiment has presented an example in which as the flow channel which is formed on the distal end portion side of the main body portion 80 of the guide member 8, the cut-offs 80c connected to the opening portion 80a on the distal end portion side are formed on the outer circumferential surface. However, application of the present invention is not limited thereto. A penetration hole may be formed at a position separate from an end surface (opening end surface) of the opening portion 80a of the guide member 8 on the distal end portion side.

### Second Modification Example

In the above-described exemplary embodiment, as an example of the guide member 8, description has been given regarding a member which has the opening portions respectively in the proximal end portion and the distal end portion. However, application of the present invention is not limited thereto. For example, a member of which the distal end portion is blocked may be adopted. In this case, on the outer circumferential surface of the main body portion 80 of the guide member 8, as the flow channel, for example, the penetration hole illustrated in the first modification example is formed.

### Third Modification Example

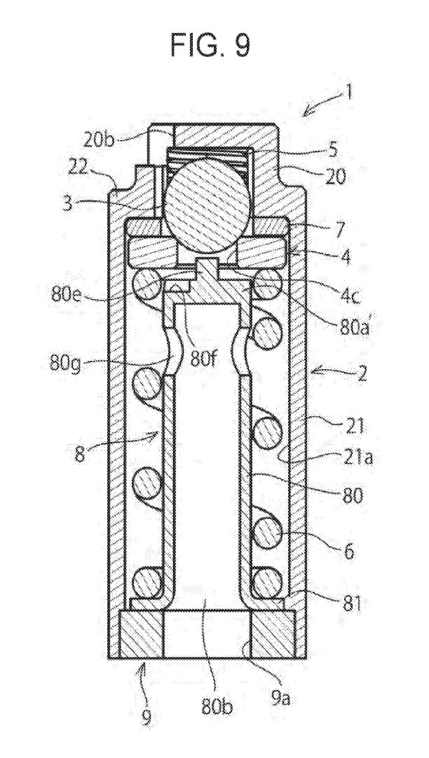

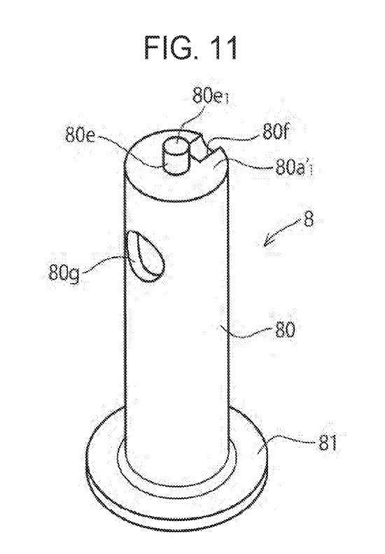

FIGS. 9 to 13 illustrate the integrated check-relief valve of a third modification example of the present invention. In FIGS. 9 to 13, the same reference numerals and signs as those in the above-described exemplary embodiment indicate the same or corresponding portions thereof.

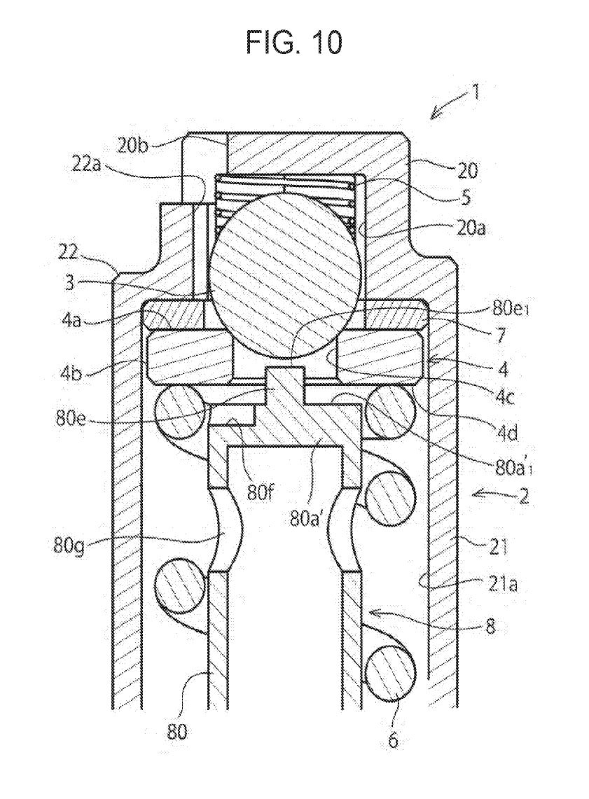

As illustrated in FIGS. 9 to 11, the guide member 8 has a blocking portion 80a′ on the distal end side thereof. On a top surface 80a′₁ of the blocking portion 80a′, a projection portion 80e projecting upward is provided. A top surface 80e₁ of the projection portion 80e has a predetermined gap with respect to the check ball 3 in a state illustrated in FIG. 10 where the check valve and the relief valve are blocked.

The projection portion 80e has a pillar shape in this example. However, the projection portion 80e is not limited thereto. The projection portion 80e may adopt a cone shape, a prism shape, a pyramid shape, or a truncated cone shape (for example, a frustum shape, a truncated pyramid shape, or the like) or can employ an arbitrary shape. In this example, the top surface 80e₁ of the projection portion 80e has a plane surface shape. However, the shape of the top surface 80e₁ is not limited thereto. The top surface 80e₁ may adopt a convex surface shape or a concave surface shape. For example, the top surface 80e₁ may be configured to have a curved concave surface along the curved outer circumference surface shape of the check ball 3 (that is, having substantially the same curvature radius as the curvature radius of the check ball 3). In addition, on the top surface 80a′₁ of the blocking portion 80a′ of a guide member 80, a flow channel 80f which is open on the outer circumferential surface is formed. Furthermore, the penetration hole 80g is formed on the outer circumferential surface.

During an operation of the liquid pressure tensioner, the operation performed when the check valve is opened due to lengthening of the plunger is approximately similar to that in the above-described exemplary embodiment. However, in this case, the distal end portion side of the main body portion 80 of the guide member 8 is blocked by the blocking portion 80a′. Therefore, the fluid supplied from the proximal end portion side to the distal end portion side of the guide member 8 moves upward through a penetration hole 80g on the distal end portion side.

Meanwhile, during an operation of the liquid pressure tensioner, the initial operation performed when the relief valve is opened due contraction of the plunger is similar to that in the above-described exemplary embodiment. However, when the relief valve is opened, the operation performed in a case where the movement amount of the valve disk 4 reaches a predetermined movement amount is different from that in the above-described exemplary embodiment.

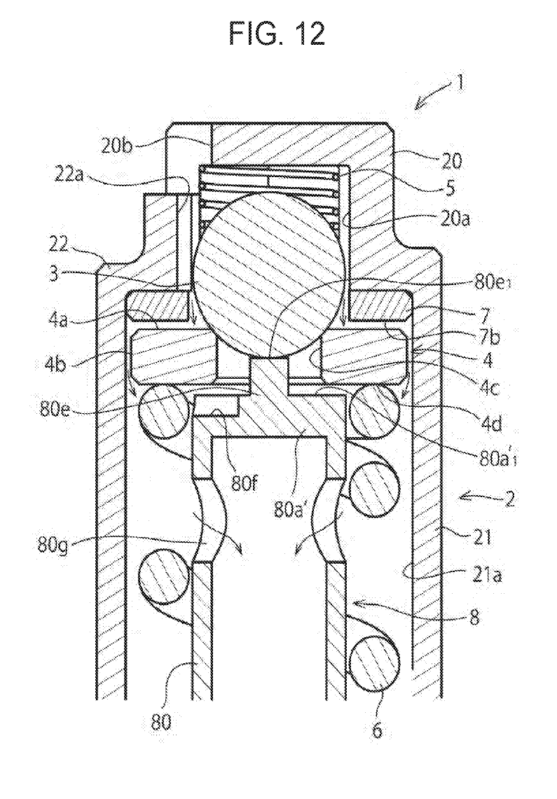

As illustrated in FIG. 12, when the movement amount of the valve disk 4 reaches a predetermined movement amount, the lower surface of the check ball 3 which moves downward together with the valve disk 4 comes into contact with the top surface 80e₁ of the projection portion 80e of the guide member 8. Accordingly, downward movement of the check ball 3 lower than the top surface 80e₁ is regulated.

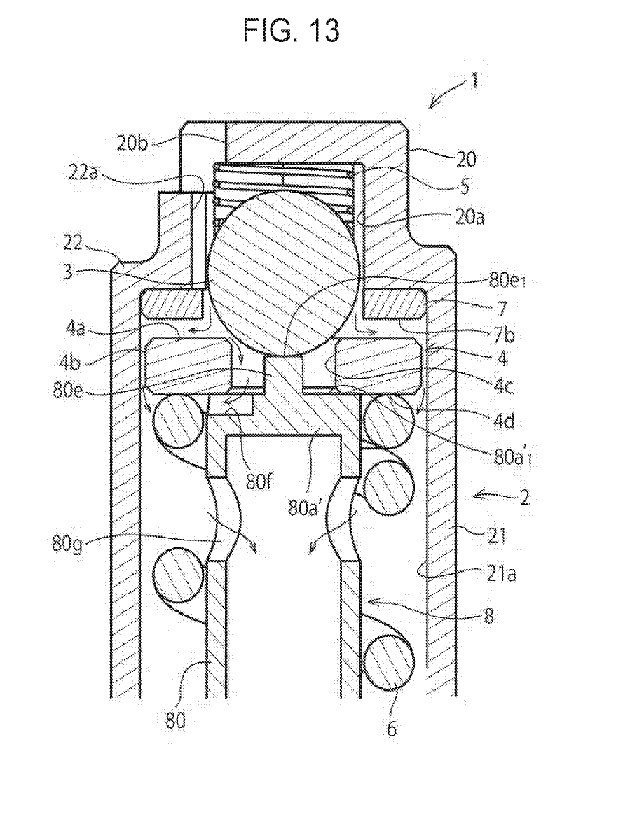

From this state, when the movement amount of the valve disk 4 increases further by causing the liquid pressure inside the chamber 104 to be higher, the valve disk 4 moves downward while causing the relief spring 6 to contract further, and the lower surface 4d of the valve disk 4 comes into contact with the top surface 80a′₁ of the blocking portion 80a′ of the guide member 8 from above. Accordingly, movement of the valve disk 4 is regulated (refer to FIG. 13). In this case, the gap between the top surface 4a of the valve disk 4 and the lower surface 7b of the pressure sheet 7 is wider. Furthermore, as the valve disk 4 moves in as state where movement of the check ball 3 is regulated by the projection portion 80e of the guide member 8, a gap is formed between the opening edge portion of the open hole 4c of the valve disk 4 and the check ball 3. Therefore, the quantity of the fluid flowing into the valve housing 2 and the guide member 8 through the gaps increases (refer to FIG. 13). In addition, in this case, the movement at the time the relief spring 6 contracts is guided by the main body portion 80 of the guide member 8.

In this manner, when the relief valve is in operation, before the retreat amount of the valve disk 4 becomes excessive, the retreat of the valve disk 4 is regulated by the top surface 80a′₁ of the blocking portion 80a′ of the guide member 8. Therefore, the valve disk 4 can be prevented from inclining inside the valve housing 2 and becoming stuck. Moreover, the guide member 8 guides movement of the relief spring 6 at all times. Therefore, it is possible to prevent the relief spring 6 from slanting in an axial line direction and spring force from the relief spring 6 counteracted by the valve disk 4 from being applied unevenly in a circumferential direction. Furthermore, the check ball 3 which retreats together with the valve disk 4 comes into contact with the projection portion 80e of the guide member 8 and downward movement thereof is regulated. Therefore, it is possible to reliably prevent a possibility that the check spring 5 exceeds the contraction state and is in a free length state.

### Fourth Modification Example

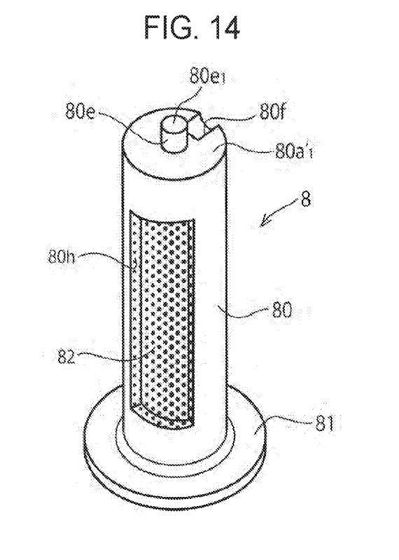

FIG. 14 illustrates a modification example of the guide member. In FIG. 14, the same reference numerals and signs as those in the above-described exemplary embodiment and the third modification example indicate the same or corresponding portions thereof. This case presents an example in which the pressure sheet 7 in the above-described exemplary embodiment is omitted. As illustrated in FIG. 14, on the outer circumferential surface of the main body portion 80 on the guide member 8, a long hole (opening portion) 80h extending in the axial direction is formed in a penetrating manner. The long hole 80h may be configured to be a pair of long holes which radially face each other (not shown in FIG. 14). In addition, this example presents the rectangular hole as the long hole. However, as the shape of the long hole 80h, it is possible to employ an arbitrary shape such as an elliptical shape, an oval shape, and the like. In addition, a plurality of the penetration holes may be disposed in the axial direction. A mesh filter (oil filter) 82 is attached to the long hole 80h. In this case, a function of the oil filter can be added to the guide member 8.

### Fifth Modification Example

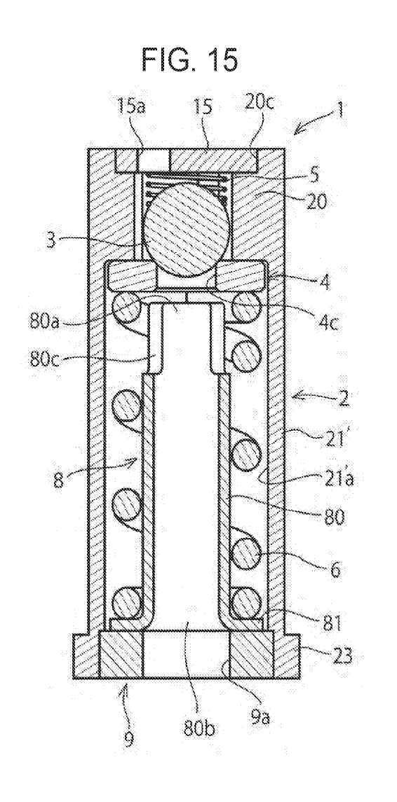

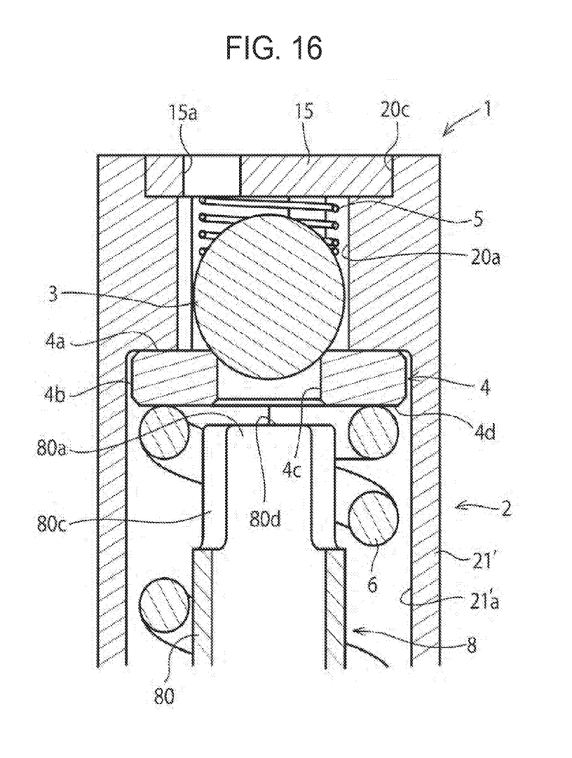

FIGS. 15 to 17 illustrate the integrated check-relief valve of a fifth modification example of the present invention. In FIGS. 15 to 17, the same reference numerals and signs as the above-described exemplary embodiment indicate the same or corresponding portions thereof.

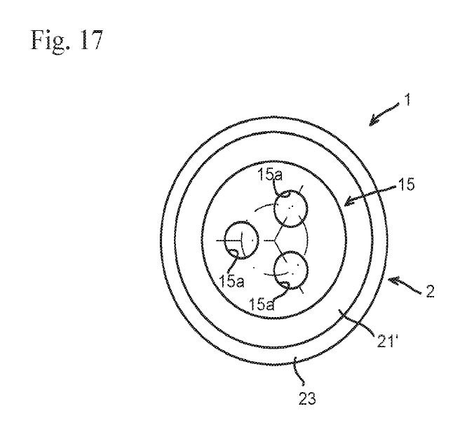

In the above-described exemplary embodiment, the valve housing 2 has the small diameter portion 20 and the large diameter portion 21 and is configured to be a member in which the step portion 22 is formed on the outer circumferential surface. However, in the fifth modification example, as illustrated in FIGS. 15 and 6, the valve housing 2 has no step portion on the outer circumferential surface and has a straight outer circumferential surface excluding the boss portion 23 on the proximal end side. In the distal end portion of the valve housing 2, a concave portion 20c communicating with the hole 20a is formed, and an end cap (lid body) 15 is fixedly attached inside the concave portion 20c by performing press-fitting or the like. As illustrated in FIG. 17, the end cap 15 is a disk-shaped member and has one or a plurality (three in this case) of penetration holes (open holes) 15a on the circumference. The upper end of the check spring 5 comes into contact with the lower surface of the end cap 15.

During an operation of the liquid pressure tensioner, the operation performed when the check valve is opened due to lengthening of the plunger is similar to that in the above-described exemplary embodiment, and the operation performed when the relief valve is opened due to contraction of the plunger is also similar to that in the above-described exemplary embodiment. However, compared to the case where movement of the fluid between the distal end portion of the valve housing 2 and the chamber 104 is performed through the cut-offs 20b of the small diameter portion 20 of the valve housing 2 in the above-described exemplary embodiment, the fifth modification example is different from the above-described exemplary embodiment with regard to the point in which movement of the fluid is performed through the penetration hole 15a of the end cap 15.

### Sixth Modification Example

In the above-described exemplary embodiment, as an example of the valve housing 2, description has been given regarding a member which has the substantially cylindrical shape. However, other tubular shapes may be employed.

### Seventh Modification Example

In the above-described exemplary embodiment, as a preferable example of the valve member, the check ball 3 configured to be a solid ball is presented. However, the geometrical shape of the valve member is suitably determined in accordance with required response characteristics. For example, a hollow ball, a disk-shaped member, a tapered member, and the like may be employed.

### Eighth Modification Example

In the above-described exemplary embodiment, as an example of the valve seat member, description has been given regarding the disk-shaped valve disk 4. However, the shape of the valve seat member is not limited to that in the above-described exemplary embodiment, and various shapes can be employed. For example, the thickness of the valve seat member, the size of the open hole, and the like can be suitably changed.

### Other Modification Examples

The exemplary embodiment and each of the modification examples described above have to be considered so as to be merely simple exemplification of the present invention in all aspects and are not limited. When those skilled in the art of the field relating to the present invention consider the above-described instruction, even though there is no specific disclosure in this specification, without departing from the gist and essential feature portions of the present invention, it is possible to establish various modification examples and other exemplary embodiments which employ the principle of the present invention.

### Alternative Application Example

In the above-described exemplary embodiment, description has been given regarding an example in which the integrated check-relief valve of the present invention is applied to a liquid pressure tensioner. However, the present invention can also be applied to other liquid pressure apparatuses (hydraulic apparatuses).

### INDUSTRIAL APPLICABILITY

The present invention is useful for an integrated check-relief valve, and is particularly suitable for an element in which a retreat amount of a valve seat member is required to be regulated when a relief valve is in operation.

1. An integrated check-relief valve comprising:
a valve housing,
wherein inside the valve housing, a valve member and a valve seat member with which the valve member can come into contact are provided so as to be movable in an axial direction, a check spring which urges the valve member to the valve seat member side and a relief spring which urges the valve seat member to the valve member side are provided, a guide member which guides the relief spring from an inner circumference side is provided, and a movement amount of the valve seat member with respect to a side where the relief spring contracts is regulated by a distal end portion of the guide member.

2. The integrated check-relief valve according to claim 1,
wherein the guide member is a tubular member, a proximal end portion and the distal end portion thereof respectively have opening portions, and a cut-off which is connected to the opening portion on the distal end portion side or a penetration hole which is separate from an opening end surface on the distal end portion side is formed on an outer circumferential surface on the distal end portion side.

3. The integrated check-relief valve according to claim 1,
wherein the guide member is a tubular member, a proximal end portion thereof has an opening portion, the distal end portion thereof is blocked, and a penetration hole which is separate from an opening end surface on the distal end portion side is formed on an outer circumferential surface of the guide member.

4. The integrated check-relief valve according to claim 3,
wherein the distal end portion of the guide member is provided with a projection portion with which the valve member can come into contact when the valve seat member retreats.

5. The integrated check-relief valve according to claim 4,
wherein a flow channel is formed in the distal end portion.

6. The integrated check-relief valve according to claim 1,
wherein a proximal end portion of the guide member is provided with a flange portion which protrudes outward, the flange portion is fixed to an end portion of the valve housing, and one end of the relief spring comes into contact with the flange portion.

7. The integrated check-relief valve according to claim 1,
wherein an opening portion is formed on an outer circumferential surface of the guide member, and an oil filter is mounted in the opening portion.

8. The integrated check-relief valve according to claim 1,
wherein the valve housing is a tubular member which is open on both a proximal end side and a distal end side, at least one open hole is formed in a lid body which is attached to an opening portion on the distal end side, and one end of the check spring comes into contact with the lid body.

9. The integrated check-relief valve according to claim 1,
wherein the valve member is a check ball.

10. A liquid pressure tensioner comprising:
the integrated check-relief valve that is disclosed in claim 1.

11. The liquid pressure tensioner according to claim 10, further comprising:
a tensioner housing that has a hole which is open in at least one end;
a plunger that is slidably accommodated in the hole and defines a chamber with respect to the hole; and
a plunger spring that is provided in the hole and urges the plunger in a direction of projecting from the hole,
wherein the integrated check-relief valve is provided inside the chamber, and an opening portion of a valve housing on a proximal end side communicates with a fluid introduction hole which is provided in the tensioner housing.

12. The liquid pressure tensioner according to claim 11,
wherein when the plunger is lengthened, if pressure of a fluid inside the chamber becomes lower than predetermined minimum pressure, the valve member moves to a side where the check spring contracts so as to form a gap between the valve member and the valve seat member, and the fluid inside the valve housing is introduced to the inside of the chamber through the gap, and
wherein when the plunger contracts, if the pressure of the fluid inside the chamber exceeds predetermined maximum pressure, the valve seat member moves to the side where the relief spring contracts so as to form a gap on the periphery of the valve seat member and the fluid inside the chamber flows into the valve housing through the gap and flows out from the opening portion of the valve housing on the proximal end side, and if the pressure of the fluid inside the chamber becomes higher, additional movement of the valve seat member is regulated by the distal end portion of the guide member.
